(19) United States
(12) Patent Application Publication
(10) Pub. No.: US 2014/0348309 A1
(43) Pub. Date: Nov. 27, 2014

(54) METHOD AND APPARATUS FOR COMMUNICATING A MESSAGE

(71) Applicants: Kerry Sean Davis, Rotorua (NZ); Perry Milton Bell, Rotorua (NZ)

(72) Inventors: Kerry Sean Davis, Rotorua (NZ); Perry Milton Bell, Rotorua (NZ)

(73) Assignee: CALLERADS LIMITED

(21) Appl. No.: 14/344,659

(22) PCT Filed: Sep. 14, 2012
(86) PCT No.: PCT/NZ2012/000166

§ 371 Date: May 16, 2014

(30) Foreign Application Priority Data
Sep. 15, 2011 (NZ) 595210
Feb. 21, 2012 (NZ) 598335

(51) Int. Cl. H04M 3/493; H04M 3/42; H04M 3/436

(52) U.S. Cl. CPC H04M 3/493; H04M 3/436; H04M 3/42365
USPC 379/88.12

(57) ABSTRACT

Systems, methods and devices are provided for communicating a message prior to enabling communication over a communication link between user devices. In one aspect, a method is provided for communicating a message prior to enabling communication over a communication link between a user device and a second user device. The method includes receiving a request to initiate the communication link from the second user device, causing a notification of the request to initiate the communication link to be generated at the user device, receiving an acknowledgement from a user of the user device that the notification has been received, causing a message to be communicated to the user of the user device, receiving a user initiated acknowledgement from the user of the user device that the message has completed, and enabling communication between the users of the user device and second user device upon receipt of the user initiated acknowledgement.

### STATEMENT OF CORRESPONDING APPLICATIONS

This application is based on the Provisional specification filed in relation to New Zealand Patent Application Number 595210 dated 15 Sep. 2011, the Provisional specification filed in relation to New Zealand Patent Application Number 598335 dated 21 Feb. 2012, and the Complete specification filed in relation to New Zealand Patent Application Number 595210 dated 27 Jun. 2012, the entire contents of which are incorporated herein by reference.

### TECHNICAL FIELD

The present invention relates to a method and apparatus for communicating a message, particularly communicating a message prior to enabling communication over a communication link between a first user device and a second user device.

### BACKGROUND ART

Advances in technology have resulted in communications devices such as mobile phones becoming a ubiquitous element of an individual's interaction with others in both a personal and professional capacity, regardless of location.

Such devices present an opportunity for advertisers to gain direct access to individuals.

Systems are known for playing messages to users on hold, replacing the dial tone or ring-back tone of a caller's device with a message, or playing the message to the caller prior to connecting the call. Such systems do not target users receiving the call, which limits the audience to which the message is delivered.

US Patent Application No. 2007/0116227 discusses delivering an audible advertisement as a ringtone to a call recipient, playing the advertisement to attract the call recipient's attention to the fact that they are receiving a call.

However, such a method has several shortcomings. If the call recipient is out of earshot of the phone, or has the phone on silent, the advertisement may be delivered without being heard. An advertiser paying for delivery of a quota of advertisements would ideally like some assurance that the advertisements are received. Further, such a technique requires storage space be available in the memory of the call recipient's phone, which is not guaranteed.

Further, it may be advantageous to provide a mechanism for notifying other parties associated with the caller or call recipient of the advertisement (or other message), via other avenues of communication in order to reach as wide an audience as possible.

It is an object of the present invention to address the foregoing problems or at least to provide the public with a useful choice.

All references, including any patents or patent applications, cited in this specification are hereby incorporated by reference. No admission is made that any reference constitutes prior art. The discussion of the reference states what their authors assert, and the applicants reserve the right to challenge the accuracy and pertinency of the cited documents. It will be clearly understood that, although a number of prior art publications are referred to herein, this reference does not constitute an admission that any of these documents forms parts of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention there is provided a method for communicating a message prior to enabling communication over a communication link between a user device and a second user device, including the steps of:
receiving a request to initiate the communication link from the second user device;
causing a notification of the request to initiate the communication link to be generated at the user device;
receiving an acknowledgement from a user of the user device that the notification has been received;
causing a message to be communicated to the user of the user device;
receiving a user initiated acknowledgement from the user of the user device that the message has completed; and
enabling communication between the users of the user device and second user device once the user initiated acknowledgement has been received.

According to another aspect of the present invention there is provided an apparatus for communicating a message prior to communication over a communication link between a user device and a second user device, the apparatus including:
a processor configured to:
   receive a request to initiate the communication link from the second user device;
   cause a notification of the request to initiate the communication link to be generated at the user device;
   receive an acknowledgement from a user of the user device that the notification has been received;
   cause a message to be retrieved from memory and communicated to the user of the user device;
   receive a user initiated acknowledgement from the user of the user device that the message has completed; and
   enable communication between the users of the user device and second user device once the user initiated acknowledgement has been received.

In an exemplary embodiment the apparatus may include a memory storing at least one message, from which the processor retrieves the message to be communicated to the user of the user device.

It is envisaged that the present invention may have particular application to telephonic devices, especially mobile telephones. However, it should be appreciated that this is not intended to be limiting.

For example, a user device may be a personal computer utilising Voice over Internet Protocol (VoIP) software or other messaging software, a personal digital assistant (PDA), or effectively any other device having means for enabling interaction over a communication link.

Reference to a communication link should be understood to mean a channel via which two or more devices may be connected, primarily with the intention of facilitating communication between the devices or users of the devices. For example, in the situation where the first and second user devices are mobile telephones, the communication link may be a channel within a cellular network over which the users call each other.

It should be appreciated that the precise nature of the communication link will vary with the type of user device being utilized with the present invention. For example, many mobile telephones have the capability to connect to wireless communication networks other than their assigned cellular network. This may be done in order to access Voice over Internet Protocol software to place a call to a personal computer utilizing compatible software.

It should be appreciated that the apparatus or system performing the present invention may interact with elements controlled by different entities in order to achieve the ultimate result.

For example, the apparatus for performing the present invention may interact with a telecommunications provider responsible for provision and control of the communications link in order to perform various steps of the present invention. In a further embodiment, the apparatus may be integrated into the systems of the telecommunications provider.

In one embodiment, the present invention may be performed at the user device itself.

For example, a set of processor executable instructions administering operation of the method may be installed on the user device. It should be appreciated that these instructions may take the form of software installed and run by an operating system of the device, or firmware embedded in the device. Reference will herein be made to the instructions being an application.

The application may interact with the operating system and/or hardware of the device to perform certain functions controlling communication between the devices and/or with the service provider. For example, the application may disable user input devices such as microphones in order to prevent communication between the devices. In doing so, it is envisaged that messages may be communicated to the user of the user device without interfering with the standard operation of the communication link provider.

It should therefore be appreciated that reference to enabling communication over the communication link between the user device and the second user device may refer to either connection of the communications link itself—for example by a communication link provider—or allowing the users to communicate, the communication link having been previously established by the communication link provider.

The request to initiate the communication link may be received from the second user device—for example on dialling of a telephone number, or selection of a contact.

Alternatively, the request to initiate the communication link may be a signal generated by the provider of the communication link on receiving the request to initiate the communication link from the second user device, the signal subsequently transmitted to the apparatus performing the present invention.

Similarly, causing the notification of the request to initiate the communication link to be generated at the second user device may include the apparatus sending a signal directly to the device. Alternatively, the apparatus may be configured to send a signal a communication link provider who in turn transmits the notification of the request to initiate the communication link to the second user device.

The notification may be any suitable means known in the art for indicating that initiation of a communication link has been requested—for example broadcasting of a ring tone, display of a visual alert, vibration of the second user device, and so on.

Preferably the acknowledgement from the user of the user device that the notification has been received is generated on the user answering the notification. The precise form that this takes will depend on the nature of the user device.

For example, in the case of a telephone the acknowledgement may be created on the user picking up or turning on the handset, or pressing an “answer” key, in response to an incoming call alert.

In the case of a messaging application associated with a computer, answering the notification may include selecting an “answer” icon using a user input device such as a keyboard, mouse, or touch sensitive device.

By requiring acknowledgement of the notification, it is envisaged that the present invention may increase the likelihood of the message being viewed and/or listened to by the user of the user device.

This is for several reasons. Firstly, by acknowledging the notification (e.g. answering a ringing phone), the user has confirmed that they are presently in control of and paying attention to the user device.

Further, the user is aware that another party has requested initiation of a communication link (e.g. has placed a telephone call to them), and may be motivated to pay attention to the message in the knowledge that completion of the message will result in connection to that party.

There is a further benefit in that accurate data may be obtained regarding the success rate of the message being received by the user of the user device.

In a preferred embodiment the message is an advertisement. An advertisement should be understood to mean the presentation of information for the purpose of promotion, typically in connection with the provision of goods and/or services.

From here on in the message may be referred to as an advertisement. However, it should be appreciated that this is not intended to be limiting, and that the message may be contain effectively any information for communication to the user of the user device. For example, the message may used as an information service, for educational purposes, or deliver information regarding services.

Reference to an advertiser should be understood to mean the party for whom the advertisement is created or delivered.

It is envisaged that advertisers may be charged per advertisement communicated to the user of the user device. By communicating the advertisement only once acknowledgement of the notification of the request to initiate the communication link has been received, the advertiser may have greater confidence as to the effectiveness of that advertisement.

In a preferred embodiment the message to be communicated to the user of the user device is selected from a plurality of messages.

It should be appreciated that the user device may communicate with other elements, such as a server, in order to perform at least one of the steps associated with the present invention. For example, the user device may communicate with a server in order to retrieve an advertisement stored in a database for delivery to the user.

However, it should be appreciated that this is not intended to be limiting. In an exemplary embodiment the user device may store at least one message in local memory, for example in the event that the advertising server is not available at that time.

Preferably, selecting the message includes selecting the message based at least in part on criteria derived from a user profile associated with the user device.

It is envisaged that the user profile may be obtained from a service provider associated with the user device, such as a telecommunications service provider. Alternatively, the user of the user device may subscribe to receive the messages/advertisements of the present invention, and enter such details in the process of subscribing.

The user profile may include demographic information such as age, gender, profession, education etc, interests or preferred subject matter for the message, or effectively any other information by which an advertiser may decide to target that user.

It is envisaged that advertisements having criteria selected by the advertiser which most closely matches the user details will be selected for communication to the user of the user device.

Preferably selecting the message includes selecting the message based at least in part on the location of the user device.

Location of the device may be obtained by any suitable means known in the art. For example, many handheld devices have GPS functionality. Alternatively, location may be approximated using the cell of the communications network in which the device is operating, or derived using techniques such as triangulation. In the case of a landline, the location may be derived from records associated with the landline.

In knowing the location of the device, even more targeted advertising may be achieved. For example, advertisers having multiple store locations can direct users to the closest store, target specific localities in which they wish to build their profile or expect best returns from, or target locations in which competitors are located or active in order to divert customers to the advertiser.

In a preferred embodiment the message is an audio message. It is envisaged that this will be particularly effective where the present invention is implemented using telephonic user devices. The advertisement may be communicated over voice channels regardless of whether the device has the capability to display visual messages.

Further, the user of the device may be more likely to listen to the advertisement in order to ensure that they are alert when communication with the other party is enabled. In the case of a visual message on a mobile phone, the user could simply hold the phone to their ear waiting for the call to be connected, effectively ignoring the advertisement.

It is envisaged that this may result in greater conversion rates (i.e. where the user acts on the advertisement), which is a key objective in advertising.

However, it should be appreciated that this is not intended to be limiting, and that the advertisement (or other messages) may be visual, audible, tactile, or a combination thereof. For example, user devices such as personal computers may be better suited to a visual or multimedia advertisement than pure audio.

In a preferred embodiment it is determined that the message has completed playing at the user device prior to enabling communication between the users of the devices. The user initiated acknowledgement may be achieved by way of selection of a particular key (for example a physical key of the device, or on-screen icon), a voice command, or any other suitable means of interaction with the user device.

While it is envisaged that the communication over the communication link may not be enabled unless the message finishes playing and is acknowledged by the user as having finished, alternative steps are envisaged.

For example, the user interrupting an advertisement may cause the advertisement to be redelivered to the second user device after the communication link has been disconnected.

It is envisaged that the present invention may be associated with a reward scheme by which the user of the user device is incentivised to receive the advertisements.

As such, in a preferred embodiment an account associated with a user of the user device is credited on determining that the message has completed.

It is envisaged that the message will complete in the situation where the user of the second user device discontinues their attempt to establish a communication link, before the message has finished being delivered to the user device.

In doing so the user of the user device may have the opportunity to have completion of the advertisement credited against their account.

It should be appreciated that other systems for rewarding the user of the user device are envisaged. For example, in one embodiment determining that the message has completed may result in adding a count towards a quota associated with a user of the user device.

It is envisaged that this may be used to reduce the fees charged to a user. However, the present invention may be used to create a revenue stream for services which are provided at no cost to users of the system. For example, users of a VoIP service may not be charged fees for basic access, but the service provider may still derive income through delivery of advertising. A user could also pay for premium services—such that they do not receive advertisements when using the service.

Further, the rewards may not be linked to the provider of the communication link. For example, the reward may be alternative goods and services (such as movie tickets, food vouchers, credit for an online application store, and so on).

It is also envisaged that the apparatus and systems associated with the present invention may be utilized in delivery of advertisements in an alternate fashion to that previously described.

The apparatus of the present invention may be configured to cause messages to be communicated to user devices without a request for initiation of a communication link with another user device.

For example, an advertiser may elect to have advertisements sent to all subscribers with particular criteria.

Alternatively, the apparatus may monitor the location of subscriber devices, whether via service providers or direct communication with the device, and send advertisements to devices within a set vicinity of an advertisers elected location.

According to a further aspect of the present invention there is provided a method for communicating a message prior to connection of a communication link between a user device and a second user device, the method including the steps of:
receiving a request to initiate the communication link from the second user device;
causing a notification of the request to initiate the communication link to be generated at the user device;
causing a message to be communicated to either or both of the user device and second user device prior to enabling connection of the connection between the user device and second user device; and
causing content relating to the message to be displayed on at least one social media system associated with at least one user account associated with the user device or devices.

In an embodiment, the method may include receiving an acknowledgement from the user device that the notification has been received.

In an embodiment, the method may include causing the message to be communicated to the second user device on receiving the acknowledgement.

According to a further aspect of the present invention there is provided an apparatus for communicating a message prior to connection of a communication link between a user device and a second user device, the apparatus including:
a processor configured to:
   receive a request to initiate the communication link from the second user device;
   cause a notification of the request to initiate the communication link to be generated at the user device;
   cause a message to be communicated to either or both of the user device and second user device prior to enabling connection of the connection between the user device and second user device; and
   cause content relating to the message to be displayed on at least one social media system associated with at least one user account associated with the user device or devices.

Reference to a social media system should be understood to mean a platform which enables users to publish material online and interact with other users, such as a blog or social networking platform such as Twitter™, Facebook™, or LinkedIn™. Members of social networking systems in particular typically interact with other members with whom they are linked socially or professionally, or share interests.

Such social media systems require registration of a user prior to enabling them to use the system. It is envisaged that on creating an account to receive the advertisements of the present invention, a user may add details sufficient to identify the social media systems to which they are a member.

Creation of the account may include authorizing the advertising system to directly access the user's social media system account(s) using details provided as the registration process. However, this is not intended to be limiting. It is envisaged that enabling content relating to the advertisements to be displayed on the at least one social media system associated with the user account associated with a user device may include sending an authorization request to the social media system account via Application Programming Interfaces (API's) of the social media system. Such an authorization request may be confirmed on the user accessing their social media account in the usual manner and expressly doing so.

In a preferred embodiment an invitation to receive messages via user device may be transmitted to other members of the social media system associated with the first or second user. It is envisaged that this may be sent to all members associated with the user, or those selected by the user. Further, the invitation may only be transmitted to members whose user information indicates that they reside in localities in which the advertising system is operating.

Alternatively or additionally, a message containing details regarding the provider of the message communication (advertising) system may be displayed on the user's social media network.

In doing so the advertising provider may advertise to a broader range of potential subscribers than may otherwise be notified of its services. It is envisaged that this may be a particularly effective avenue for advertising the service, as the peers of the subscribed user may be more likely to belong to a demographic agreeable to subscribing to the service.

In operation, once a message has been received on the user device(s), content relating to the message may then be displayed on at least one social media system associated with a user account associated with the user device(s). This may follow confirmation that the message has completed, and/or on the express request by the user that the content be displayed on the social media system.

In a preferred embodiment, the content displayed on the social media system includes information regarding the entity or event to which the message is directed. For example, if the message advertises a consumer goods store, the content may include the name of the store.

In doing so, the message is delivered both to a subscriber and their wider network with which they interact online.

It is envisaged that the content may include a link to the advertiser's website. Many search engines base the rank of a website at least in part on the number of links made to that website from other sources, and the volume of traffic resulting from such sources. By providing another avenue for the advertiser's website to be linked to, the present invention enables search engine optimization (SEO).

Alternatively, the content may direct viewers to the advertiser's account on the social media platform rather than an outside web presence. For example, the present invention may cause the user's account to “like” the Facebook™ page of the advertiser.

Preferably the content also includes information pertaining to the provider of the message communication system. Similarly to above, this may include a link to the provider's website. In doing so, the provider performs search engine optimization, and advertises its services concurrently with delivery of the advertising it is contracted to deliver.

Communication with the social media system and subsequent display of the content may be achieved via the Application Programming Interfaces (API's) of the social media systems.

For a firmware and/or software (also known as a computer program) implementation, the techniques of the present invention may be implemented as instructions (for example, procedures, functions, and so on) that perform the functions described. It should be appreciated that the present invention is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present invention may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

Embodiments of the present invention may provide at least the following advantages:
greater likelihood of conversion due to recipient of advertisement being motivated to pay attention in readiness for communicating with the other party;
ability to associate a user profile with a user device enables highly targeted advertising to be delivered—including targeting areas in which competitors are located in order to acquire their customers;
delivering the advertisement only on acknowledgement that the user is present increases likelihood that advertisement will be viewed/listened to, and enables more accurate record keeping for billing purposes; and
low cost of individual advertisements provides greater accessibility to smaller advertisers;
nature of technology improves ease of access to advertising, and flexibility in creating or adjusting advertising to suit current needs;
not restricted to specific devices or operating systems/platforms, providing the ability to deliver advertisements over a wide range of communication systems;
access to a subscriber's online network to deliver advertising to the subscriber's peers—both of the advertisement itself and also the advertising delivery service; and
broader benefits of search engine optimization through provision of back links.

### BRIEF DESCRIPTION OF THE DRAWINGS

FIG. 1 is a diagram of a system in which embodiments of the present invention may be implemented;

FIG. 2 is a flow diagram illustrating an exemplary method of initiating an advertising campaign according to one aspect of the present invention;

FIG. 3 is a flow diagram illustrating an exemplary method by which a user may subscribe to receive advertisements according to one embodiment of the present invention;

FIG. 4 is a flow diagram illustrating another exemplary method by which a user may subscribe to receive advertisements according to one embodiment of the present invention;

FIG. 5 is a flow diagram illustrating an exemplary method of communicating an advertisement prior to enabling communication over a communication link according to one embodiment of the present invention;

FIG. 6 is a flow diagram illustrating another exemplary method of communicating an advertisement prior to enabling communication over a communication link according to one embodiment of the present invention;

FIG. 7 is a flow diagram illustrating an exemplary method of administering a reward system according to one embodiment of the present invention;

FIG. 8 is a flow diagram illustrating another exemplary method of communicating an advertisement prior to enabling communication over a communication link according to one embodiment of the present invention;

FIG. 9 is a flow diagram illustrating a further an exemplary method of communicating an advertisement prior to enabling communication over a communication link according to one embodiment of the present invention;

FIG. 10 is a flow diagram illustrating a method of delivering advertisements according to another embodiment of the present invention.

### BEST MODES FOR CARRYING OUT THE INVENTION

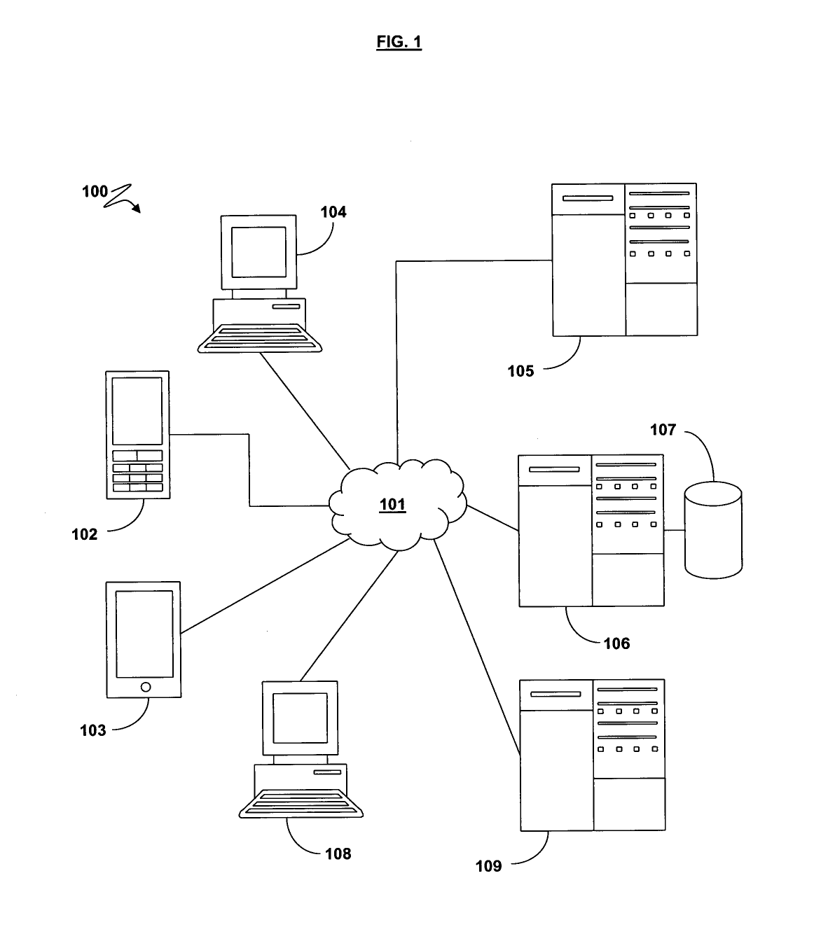

FIG. 1 illustrates a system (generally indicated by arrow 100) in which the present invention may be implemented.

The system 100 contains a network 101 over which various communication links between devices within the system 100. While the network 101 is illustrated as a single component, it should be appreciated that it may be composed of a number of sub-networks, potentially operating using distinct technologies—e.g. wired or wireless, fibre optic or radio.

A number of user devices are connected to the network 101 including a first mobile phone 102 a second mobile phone 103 and a personal computer 104.

The system 100 also includes a service provider server 105 connected to the network and configured to facilitate connection of a communication link between the user devices.

For example, if a call between the first mobile phone 102 and second mobile phone 103 is desired, the service provider server 105 will receive a request for the call to be connected from the first mobile phone 102 and connect the call to the second mobile phone 103.

An advertising server 106 is also connected to the network 101 along with a storage unit 107. The storage unit 107 stores advertisements to be sent in accordance with the present invention.

An advertiser's computer 108 is also connected to the network to facilitate the creation of advertisements.

An advertiser may use the computer 108 or any other suitable device, to access an account associated with the service provided by the operator of the advertising server.

In one embodiment the operator of the advertising server may be the service provider, or an entity controlled by the service provider. However, it should be appreciated that this is not intended to be limiting. In some embodiments the operator of the advertising server may be contracted by the service provider to perform and monitor operation of the invention, while in others they may operate independently.

The advertising server 106 and/or user devices may communicate with at least one social media system, operated on the social media server 109, via an application programming interface (API) of the social media system.

It should be appreciated that user devices 102, 103 and 104, advertiser's computer 108, and servers 105, 106, and 109 may each include at least one processor (not shown) configured to perform at least part of the exemplary processes described below, using computer executable instructions stored in memory (not shown) at each device or accessed over network 101.

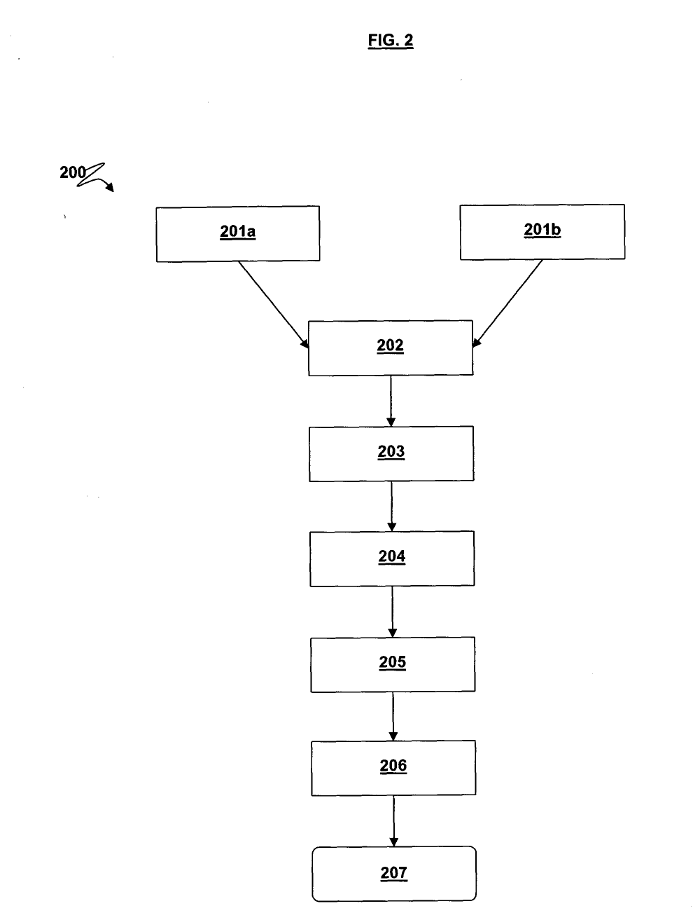

FIG. 2 illustrates the process 200 by which an advertiser initiates an advertising campaign.

In step 201a, the advertiser creates an advertisement. For the purposes of this discussion, the advertisement should be understood to be an audible advertisement. Ideally the advertisement will be no longer than 10 seconds. This advertisement can be a simple audio file created on a home computer, or a professionally recorded advertisement.

Alternatively, in step 201b the advertiser may place a request for the creation of the advertisement by the operator of the advertising system.

In step 202, the advertiser creates an advert profile which includes target criteria such as age range, city, interests, specific GPS locations, marital status, occupation, industry, and/or income range.

In step 203 the advertiser specifies a start and end date between which the advertisements are to be delivered.

The advertiser then chooses a budget for the advertising campaign in step 204.

An estimate of the likely size of the target audience is then calculated based on the parameters entered in steps 202-203, and presented to the advertiser in step 205.

If the advertiser is providing the advertisement, then this is uploaded to the advertising server 106 and stored in the storage unit 107 in step 206. Existing advertisements can be copied and edited and run as part of new campaigns.

In step 207 the advertiser then authorises their advertising campaign. The advertiser can access their account via the internet to view all campaigns and also view how many ads have played, when they have been played, GPS location (where available) etc. They are also able to to see billing and print invoices.

FIG. 3 illustrates the process 300 by which a user subscribes to receive the advertisements at their user device.

At step 301 the user registers with the advertising server 107 and completes a user registration which includes comprehensive demographic information—for example age, city, interests, marital status, occupation, industry, and/or income range.

At step 302 the user registers a user device, or account accessed from the user device with the user profile. For example, the user may register the phone number of the mobile phone 103, or a VoIP software account name to be accessed by the personal computer 104. The user may also provide details of social media systems to which they belong, and provide sufficient details to identify their account(s) with the social media systems.

At step 303 the user also decides the amount of rewards they would like to receive, for example how many free minutes, or value of a voucher, and are presented with an estimate of how many advertisements they would need to listen to in order to get these rewards.

Preferably the user will be required to listen to their full quota of advertisements in order to receive their reward, with no pro-rata adjustment provided. However it should be appreciate that this is not intended to be limiting.

At step 304 the user confirms that all information is acceptable and agrees to the terms and conditions, and a verification message is sent to the device i.e. an SMS message to the mobile phone 103, or email to a nominated account which may be accessed by the computer 104. An authorisation request is also transmitted to the social media system account designated by the user during subscription.

The user may be required to update and/or confirm their profile periodically to ensure that the profile information evolves as the users profile and lifestyle changes.

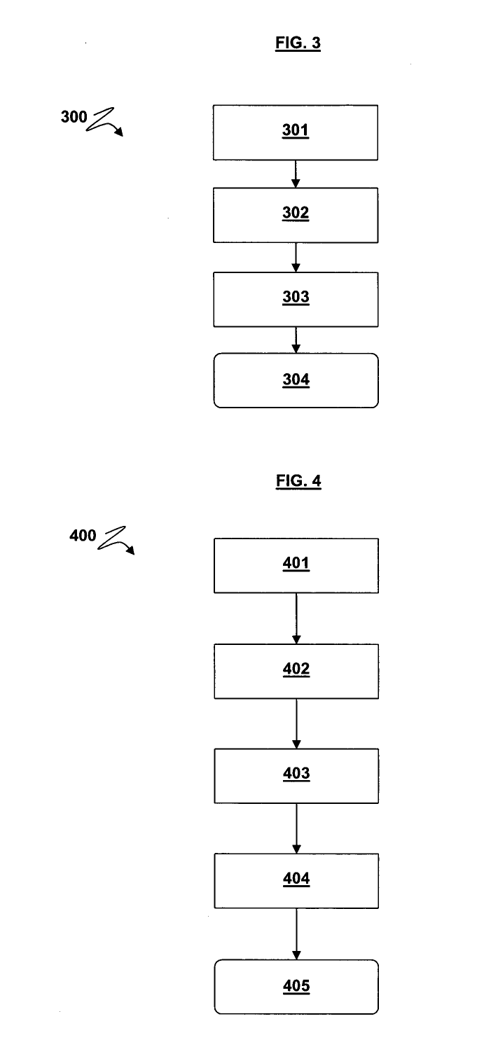

FIG. 4 illustrates an alternative process 400 by which a user subscribes to receive the advertisements at their user device.

At step 401 the user downloads an application for enabling delivery and monitoring of advertising on their user device.

At step 402 the user registers with the advertising server 107 via the application and completes a user registration which includes comprehensive demographic information—for example age, city, interests, marital status, occupation, industry, and/or income range.

At step 403 the user registers a user device, or account accessed from the user device with the user profile. For example, the user may register the phone number of the mobile phone 103, or an account name for an application to be operated by the phone 103, or a VoIP software account name to be accessed by the personal computer 104. The user may also provide details of social media systems to which they belong, and provide sufficient details to identify their account(s) with the social media systems.

At step 404 the user also decides the amount of rewards they would like to receive, for example how many free minutes, and are presented with an estimate of how many advertisements they would need to listen to in order to get these rewards.

Preferably the user will be required to listen to their full quota of advertisements in order to receive their reward, with no pro-rata adjustment provided. However it should be appreciate that this is not intended to be limiting.

At step 405 the user confirms that all information is acceptable and agrees to the terms and conditions, and a verification message is sent to the device i.e. an SMS message to the second mobile phone 103, or email to a nominated account which may be accessed by the computer 104. An authorisation request is also transmitted to the social media system account designated by the user during subscription.

It should be appreciated that the various steps of FIG. 3 and FIG. 4 have been illustrated for the purposes of clarity, but that these may be performed in a different order than shown, or steps combined, without departing from the present invention.

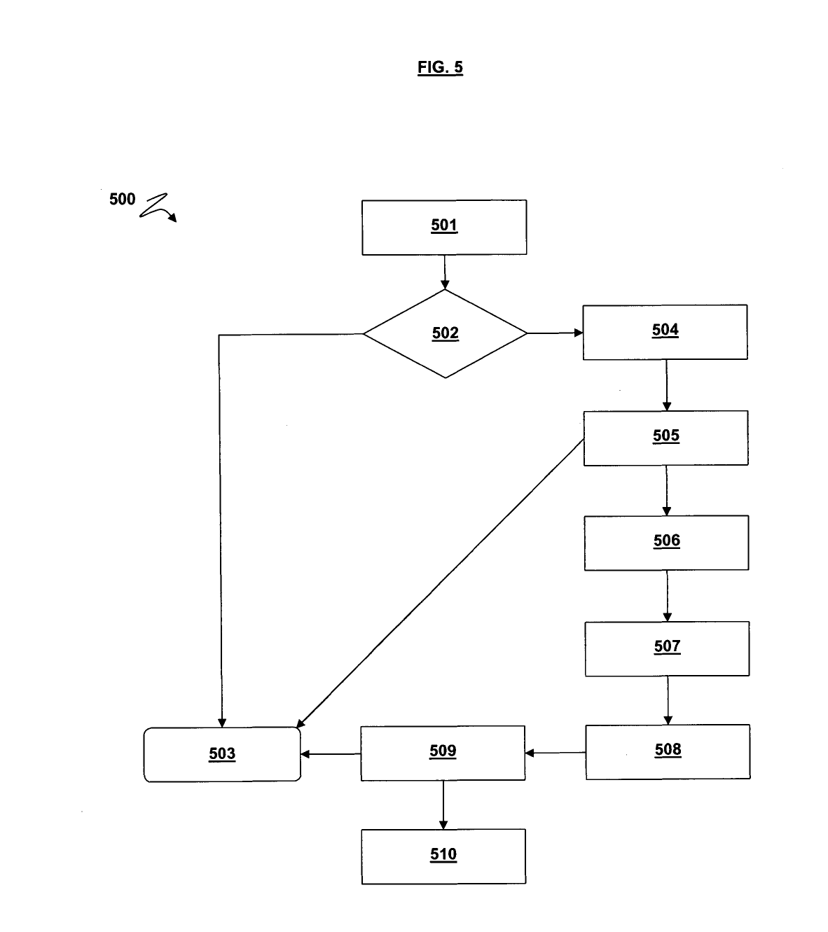

FIG. 5 illustrates a method for communicating an advertisement prior to connection of a communication link between the first mobile phone 102 and the second mobile phone 103.

At step 501 a user of the first mobile phone 102 dials the number of the second mobile phone 103, transmitting a request to initiate the communication link, or call, to the service provider server 105.

At step 502, the service provider server 105 determines whether the second mobile phone 103 is associated with a subscription to the adverting service.

If the second mobile phone 103 is not associated with a subscription, the call is connected at step 503.

If the second mobile phone 103 is associated with a subscription, the service provider server 105 indicates to the advertising server 106 that a request to initiate a communication link with the second mobile device has been received at step 504.

At step 505 the advertising server 106 determines which advertisement stored in the storage unit 107 best matches the user profile associated with the second mobile phone 103, and the current GPS location of the mobile phone 103—if available.

If no suitable advertisement is identified, the advertising server 106 notifies the service provider server 105, the service provider server 105 notifies the second mobile phone 103 of the call from the first mobile phone 102, and if answered the call is connected at step 503.

If a suitable advertisement is identified, the advertising server 106 notifies the service provider server 105, and the service provider server 105 notifies the second mobile phone 103 of the call from the first mobile phone 102 at step 506.

At step 507, the user of the second mobile phone 103 answers the notification, and the advertising server 106 delivers the selected advertisement to the second mobile phone 103 via the service provider server 105.

At step 508, once the advertisement has completed the user is asked for confirmation that they have listened to the call by a keypad press, voice command or similar command. The user cannot verify they have listened to the advertisement until it has finished playing i.e. there is no keypad response other than the designated confirmation key, or disconnection of the call.

At step 509, the advertising server 106 receives confirmation that the advertisement has been completed, and confirms to the service provider server 105 that this has occurred. The call is then connected at step 503.

During steps 504 to 508, the user of the first mobile phone 102 hears a ring back tone, as normal.

The advertising server 106 also records completion of the advertisement against the account associated with the subscription at step 510, together with other details such as GPS location, time etc.

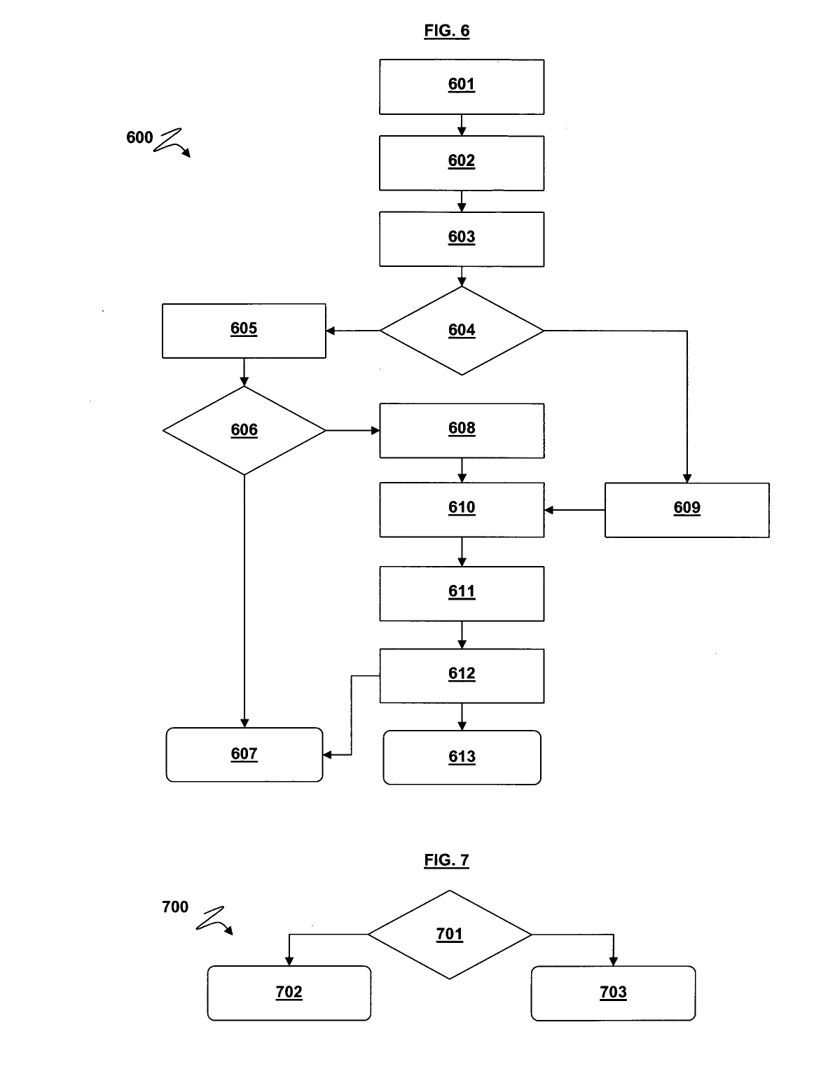

FIG. 6 illustrates an alternative process 600 for the delivery of advertisements within the system 100 of FIG. 1.

At step 601 a user of the first mobile phone 102 dials the number of the second mobile phone 103, transmitting a request to initiate the communication link, or call, to the service provider server 105.

At step 602, the service provider relays the request to initiate the communication link to the second mobile phone 103.

At step 603, if the user answers the second mobile phone 103 an application installed on the second mobile phone 103 disables communication between the users by controlling associated functions on the second mobile phone 103.

At step 604, the application checks whether a communication link with the advertising server 106 is available, for example over a Wifi network.

If so, at step 605 the application indicates to the advertising server 106 that a communication link with the second mobile device 103 is desired.

At step 606 the advertising server 106 determines which advertisement stored in the storage unit 107 best matches the user profile associated with the second mobile phone 103, and the current GPS location of the mobile phone 103—if available.

If no suitable advertisement is identified, the advertising server 106 notifies the application and the application enables communication between the users at step 607, for example communicating with the service provider 105 to connect the call.

If a suitable advertisement is identified, the advertising server 106 delivers the selected advertisement to the application at the second mobile phone 103 at step 608.

Alternatively, particularly if a connection to the advertising server 106 is not available at step 604, the application may access a previously saved advertisement from its dedicated memory in step 609.

At step 610 the application plays the advertisement to the user of the second mobile phone 103.

At step 611 once the advertisement has completed the user is asked for confirmation that they have listened to the call by a keypad press, voice command or similar command. Preferably the user cannot verify they have listened to the advertisement until it has finished playing i.e. there is no keypad response other than the designated confirmation key, or disconnection of the call.

During steps 603 to 612, the first mobile phone 102 may continue to hear a ring-back tone, or may be played a message—for example advising the user of the first mobile phone 102 that their call will be connected shortly.

At step 612, the application receives the confirmation from the user, and the application enables communication between the users at step 608.

At step 613 the advertising server 106 receives confirmation from the application that the advertisement has been completed. The advertising server 106 also records completion of the advertisement against the account associated with the subscription, together with other details such as GPS location, time etc.

FIG. 7 illustrates a process 700 by which the reward system is administered.

At step 701, the advertising server 106 determines whether a subscriber has received and listened to their quota of advertisements for a set time period. Alternatively, the advertising server 106 determines the number of advertisements which have been listened to by a subscriber. Preferably, determining that the advertisements have been listened to includes determining that confirmation from the user has been received by the advertising sever 106.

If the full quota has been listened to then confirmation is sent to the service provider server 105 at step 702, where call minutes or similar rewards are allocated to the subscriber's mobile phone. Alternatively, a reward may be determined based on the number of ads listened to—rather than achievement of a single quota. Further, the advertising server may log the achievement of the quota or number of advertisements and issue the reward directly. It should be appreciated that determination and delivery of the reward may be performed by other entities, depending on the embodiment of the present invention.

In one embodiment, if the full quota has not been listened to then no confirmation is sent to the service provider server 105 (or logged at the advertising server 106), and a message is sent to the user at step 703 to remind them that they need to ensure they listen to their full quota or log-in to their account and reduce their quota to a more realistic target.

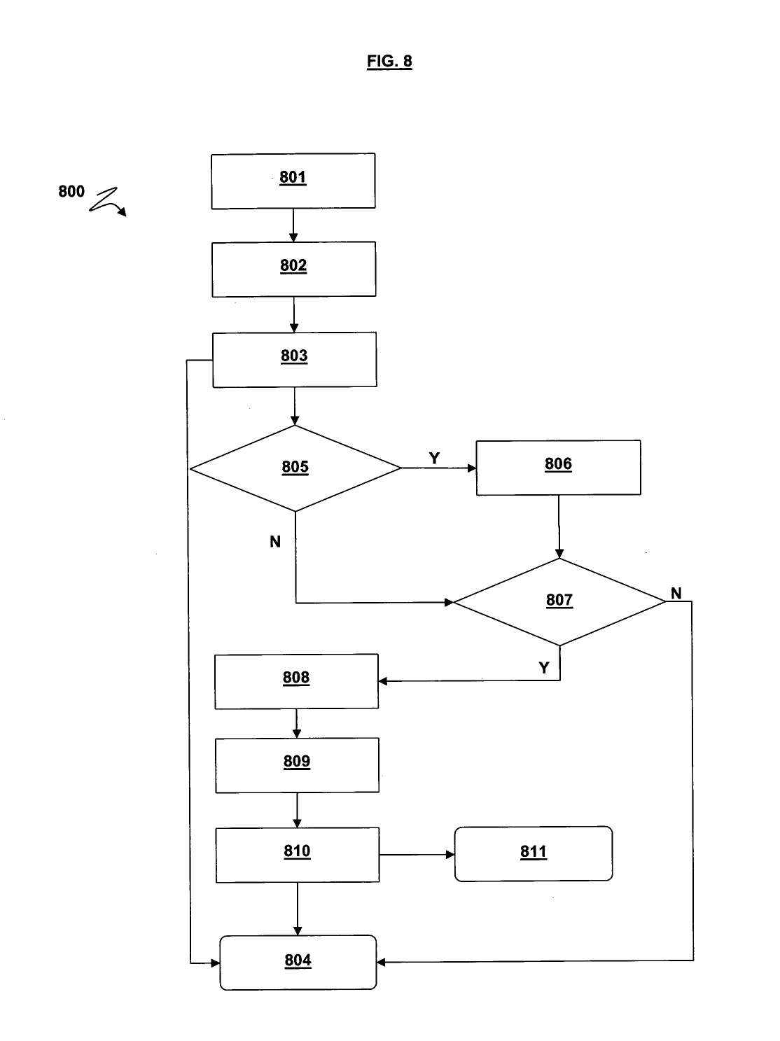

FIG. 8 illustrates a process 800 for the display of content on a social media system, the process being performed within the system 100 of FIG. 1.

At step 801 a user of the first mobile phone 102 dials the number of the second mobile phone 103, transmitting a request to initiate the communication link, or call, to the service provider server 105.

At step 802, the service provider server 105 determines whether the either the first 102 or second mobile phone 103 is associated with a subscription to the advertising service.

If either the first mobile phone 102 or second mobile phone 103 is associated with a subscription, the service provider server 105 indicates to the advertising server 106 that a request to initiate a communication link has been received at step 803.

If neither mobile phone is associated with a subscription, the service provider server 105 notifies the second mobile phone 103 of the call from the first mobile phone 102 and the call is connected at step 804 once the notification is answered.

At step 805 the advertising server 106 determines which advertisement stored in the storage unit 107 best matches the user profile associated with the subscriber's phone and the current GPS location of the mobile phone—if available.

If the first mobile phone 102 has an associated subscription, the advertising server 106 delivers the selected advertisement to the first mobile phone 102 via the service provider server 105 at step 806.

If the first mobile phone 102 does not have a subscription, the user may continue to hear a ring back tone while the advertising server 106 notifies the service provider server 105 if a suitable advertisement has been identified, and the service provider server 105 notifies the second mobile phone 103 of the call from the first mobile phone 102 at step 807. If no suitable advertisement is identified, the call is connected at step 804 once the notification is answered.

At step 808, the user of the second mobile phone 103 answers the notification, and the advertising server 106 delivers the selected advertisement to the second mobile phone 103 via the service provider server 105.

At step 809, once the advertisement has completed the user is asked for confirmation that they have listened to the advertisement by a keypad press, voice command or similar command. The user cannot verify they have listened to the advertisement until it has finished playing i.e. there is no keypad response other than the designated confirmation key, or disconnection of the call.

At step 810, the advertising server 106 receives confirmation that the advertisement has been completed, and confirms to the service provider server 105 that this has occurred. The call is then connected at step 804.

At step 811, the advertising server 106 causes an advertisement containing a link to a designated website of the advertiser associated with the advertisement delivered to either or both the first mobile phone 102 or second mobile phone 103 to be published on the social media network account of the associated user via the API of the social media server 109.

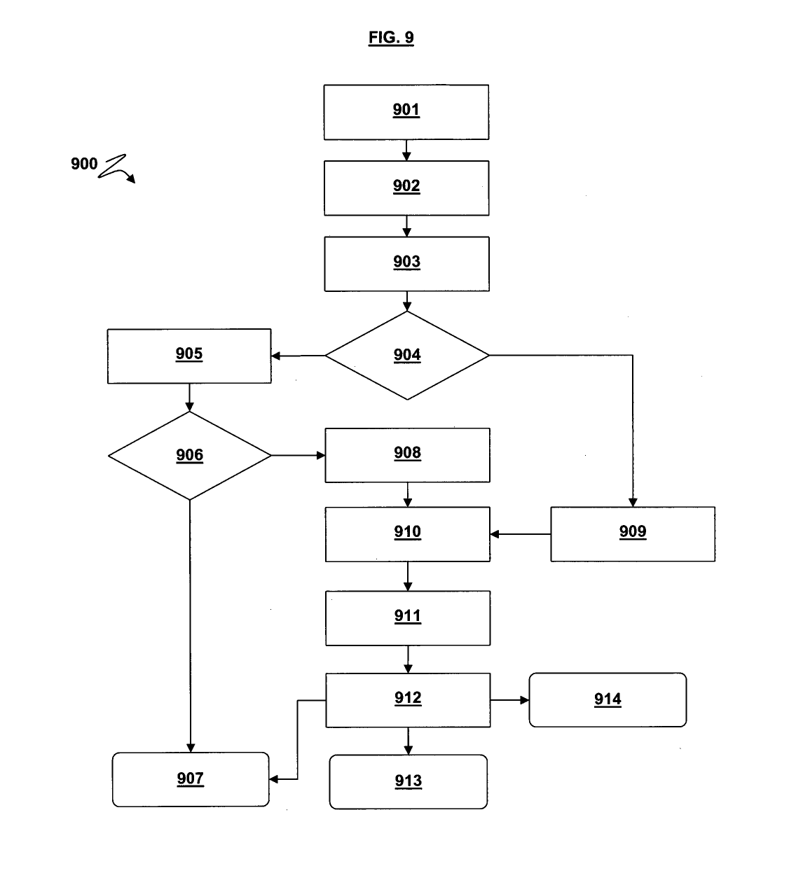

FIG. 9 illustrates a process 900 for the display of content on a social media system, the process being performed within the system 100 of FIG. 1.

At step 901 a user of the first mobile phone 102 dials the number of the second mobile phone 103, transmitting a request to initiate the communication link, or call, to the service provider server 105.

At step 902, the service provider relays the request to initiate the communication link to the second mobile phone 103.

At step 903, if the user answers the second mobile phone 103 in response to receiving the relayed request to initiate the communication link an application installed on the second mobile phone 103 application disables communication between the users by controlling associated functions on the second mobile phone 103.

At step 904, the application checks whether a communication link with the advertising server 106 is available, for example over a Wifi network.

If so, at step 905 the application indicates to the advertising server 106 that a communication link with the second mobile device 103 is desired.

At step 906 the advertising server 106 determines which advertisement stored in the storage unit 107 best matches the user profile associated with the second mobile phone 103, and the current GPS location of the mobile phone 103—if available.

If no suitable advertisement is identified, the advertising server 106 notifies the application and the application enables communication between the users at step 907, for example communicating with the service provider 105 to connect the call.

If a suitable advertisement is identified, the advertising server 106 delivers the selected advertisement to the application at the second mobile phone 103 at step 908.

Alternatively, if a connection to the advertising server 106 is not available at step 904, the application may access a previously saved advertisement from its dedicated memory in step 909.

At step 910 the application plays the advertisement to the user of the second mobile phone 103.

At step 911 once the advertisement has completed the user is asked for confirmation that they have listened to the call by a keypad press, voice command or similar command. The user cannot verify they have listened to the advertisement until it has finished playing i.e. there is no keypad response other than the designated confirmation key, or disconnection of the call.

At step 912, the application receives the confirmation from the user, and the application enables communication between the users at step 908.

At step 913 the advertising server 106 receives confirmation from the application that the advertisement has been completed. The advertising server 106 also records completion of the advertisement against the account associated with the subscription, together with other details such as GPS location, time etc.

At step 914, the advertising server 106 causes an advertisement containing a link to a designated website of the advertiser associated with the advertisement delivered to either or both the first mobile phone 102 or second mobile phone 103 to be published on the social media network account of the associated user via the API of the social media server 109.

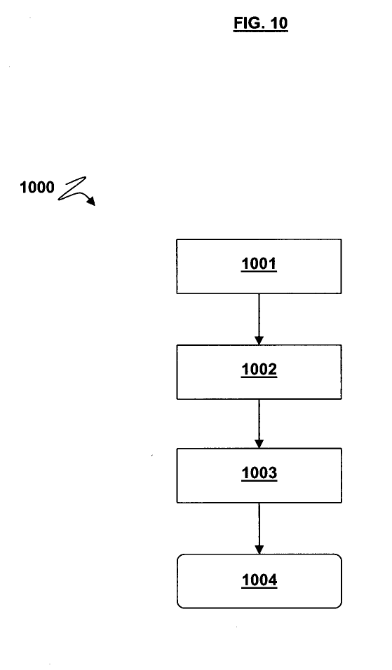

FIG. 10 illustrates an alternative process 1000 for the delivery of advertisements within the system 100 of FIG. 1.

At step 1001, the advertising server 106 determines the current location of the user devices, e.g. the first and second mobile phones 102, 103 and the personal computer 104, of subscribers—either by direct communication with the devices or via service provider server 105.

At step 1002, the advertising server 106 determines whether the current location of the devices is within a set proximity of a location associated with an advertisement stored in the storage unit 107.

At step 1003, the advertising server 106 initiates a communication link with the device via the service provider server 105, causing the device to be notified of an incoming communication.

Alternatively, the advertising server 106 may cause the previously referred to application on the user device to issue a notification of an advertising event (i.e. that an advertisement is ready to be delivered to them).

At step 1004, if the notification or advertising event is answered by the user of the user device 102, 103, 104, the advertising server causes the selected advertisement(s) to be delivered to the user device or devices.

Aspects of the present invention have been described by way of example only and it should be appreciated that modifications and additions may be made thereto without departing from the scope thereof as defined in the appended claims.

1. A method for communicating a message prior to enabling communication over a communication link between a user device and a second user device, the method comprising the steps of:
receiving a request to initiate the communication link from the second user device;
causing a notification of the request to initiate the communication link to be generated at the user device;
receiving an acknowledgement from a user of the user device that the notification has been received;
causing a message to be communicated to the user of the user device;
receiving a user initiated acknowledgement from the user of the user device that the message has completed; and
enabling communication between the users of the user device and second user device once the user initiated acknowledgement has been received.

2. The method as claimed in claim 1, wherein the user initiated acknowledgement is generated on selection of a key on the user device.

3. The method as claimed in claim 1, wherein the user initiated acknowledgement is disabled until completion of the message.

4. The method as claimed in claim 1, wherein the message is an audio message.

5. The method as claimed in claim 1, comprising selecting the message to be communicated to the user of the user device from a plurality of messages.

6. The method as claimed in claim 5, wherein selecting the message comprises selecting the message based at least in part on criteria derived from a user profile associated with the user device.

7. The method as claimed in claim 5, wherein selecting the message comprises selecting the message based at least in part on the location of the user device.

8. The method as claimed in claim 2, comprising crediting an account associated with a user of the user device on determining that the message has completed.

9. The method as claimed in claim 2, comprising adding a count towards a quota associated with a user of the user device on determining that the message has completed.

10. The method as claimed in claim 1, wherein the message is an advertisement.

11. (canceled)

12. An apparatus for communicating a message prior to communication over a communication link between a user device and a second user device, the apparatus comprising:
a processor configured to:
receive a request to initiate the communication link from the second user device;
cause a notification of the request to initiate the communication link to be generated at the user device;
receive an acknowledgement from a user of the user device that the notification has been received;
cause a message to be retrieved from memory and communicated to the user of the user device;
receive a user initiated acknowledgement from the user of the user device that the message has completed; and
enable communication between the users of the user device and second user device once the user initiated acknowledgement has been received.

13. The apparatus as claimed in claim 12, wherein the user initiated acknowledgement is generated on selection of a key on the user device.

14. The apparatus as claimed in claim 12, wherein the processor is configured to disable the user initiated acknowledgement until completion of the message.

15. The apparatus as claimed in claim 12, wherein the message is an audio message.

16. The apparatus as claimed in claim 12, wherein the message to be communicated to the user of the user device is selected from a plurality of messages.

17. The apparatus as claimed in claim 16, wherein the message is selected based at least in part on criteria derived from a user profile associated with the user device.

18. The apparatus as claimed in claim 16, wherein the message is selected based at least in part on the location of the user device.

19. The apparatus as claimed in claim 13, wherein the processor is configured to cause an account associated with the user of the user device to be credited on determining that the message has completed.

20. The apparatus as claimed in claim 13, wherein the processor is configured to cause a count to be added towards a quota associated with the user of the user device on determining that the message has completed.

21. The apparatus as claimed in claim 12, wherein the message is an advertisement.

22. The apparatus as claimed in claim 12, wherein the apparatus is the user device.

23-25. (canceled)

26. An article of manufacture having nontransitory computer storage medium storing computer readable program code using a processor to implement a method for communicating a message prior to enabling communication over a communication link between a user device and a second user device, the code comprising:
computer readable program code receiving a request to initiate the communication link from the second user device;
computer readable program code causing a notification of the request to initiate the communication link to be generated at the user device;
computer readable program code receiving an acknowledgement from a user of the user device that the notification has been received;
computer readable program code causing a message to be communicated to the user of the user device;
computer readable program code receiving a user initiated acknowledgement from the user of the user device that the message has completed; and
computer readable program code enabling communication between the users of the user device and second user device once the user initiated acknowledgement has been received.
